(19) United States
(12) Patent Application Publication
(10) Pub. No.: US 2004/0219458 A1
(43) Pub. Date: Nov. 4, 2004

(54) Methods and apparatus for use in photopolymer plate manufacture

(76) Inventors: Paul Mayo Holt, Uppingham (GB); Maria Peneva Dincheva, Corby (GB)

Correspondence Address: KOLISCH HARTWELL, P.C., 520 S.W. YAMHILL STREET, SUITE 200, PORTLAND, OR, 97204, US

(21) Appl. No.: 10/776,897

(22) Filed: Feb. 10, 2004

Related U.S. Application Data
(63) Continuation of application No. PCT/GB02/03697, filed on Feb. 20, 2003.
(63) Continuation-in-part of application No. 09/985,034, filed on Nov. 1, 2001, now Pat. No. 6,737,219.

(30) Foreign Application Priority Data
Aug. 10, 2001 (GB) 0119546.0
Feb. 20, 2003 (WO) 03/014832 A1

(51) Int. Cl. G03C 1/73

(52) U.S. Cl. 430/281.1

(57) ABSTRACT

The invention provides a photopolymer package for use in making a hand stamp plate, the package consisting of a sachet containing a photocurable liquid polymer, the walls of the sachet being formed of material capable of being released from the cured photopolymer. Methods for the formation of the package and the hand stamp plate are also provided. The invention eliminates the requirement for the use of a backing layer in the package and thereby offers significant advantages over the prior art in terms of cost and efficiency. The invention describes how that sachet can be inserted in a holding device to expose it to UV radiation to produce the printed surface. The invention describes a novel method for spraying the sachet with a liquid to enable it to be dry post-exposed in a new type of exposure unit. It describes how this exposure unit benefits from the simplicity of the sachet concept to require no movable upper lid. This unit combines the post exposure process with the exposure process without the requirement for a water bath.

### CROSS-REFERENCES TO RELATED APPLICATIONS

This application is a continuation of International Application No. PCT/GBO2/03697, which was published in English as International Publication No. WO 03/014832 A1 on Feb. 20, 2003, and which. Claims the benefit of the priority of United Kingdom Patent Application No. 0119546.0, filed Aug. 10, 2001, and the benefit of the priority of U.S. patent application Ser. No. 09/985,034, filed Nov. 1, 2001, and which is incorporated herein by reference in its entirety for all purposes

This application is also a continuation-in-part of U.S. patent application Ser. No. 09/985,034, filed Nov. 1, 2001, which is incorporated herein by reference in its entirety for all purposes.

### BACKGROUND

The present invention relates to photopolymer plates. In part it concerns various aspects of a system useful for making hand stamps. The system offers significant benefits over current technology. In other respects, the invention relates in particular to a method and device for dry post-exposure of photopolymer printing plates and to novel exposure apparatus.

Numerous printing techniques are known today and many use printing plates. An important plate printing technique is flexographic printing, which in essence is a rotary printing method that uses flexible resilient sheets with raised images and fast-drying inks. Flexography thus prints from a flexible printing plate that is wrapped around a rotating cylinder. The plate is usually made of natural or synthetic rubber or from photopolymer backed by a reinforcing sheet.

Photopolymer printing plates comprising a layer of resin adhered to a backing sheet and made using liquid photopolymer are ubiquitous in flexographic printing.

Flexible printing plates are used also in hand stamp printing, which differs from flexographic printing in using a flat printing plate. As in the case of flexography, the plate comprises a layer of cured resin having an image surface and, on the opposite face of the resin layer, a backing sheet firmly adhered to the resin.

Photopolymer, therefore, is commonly used to make hand stamps and has replaced rubber as the material of choice in the manufacture of business stamps. The process of manufacturing an image using photopolymer resin requires the use of an exposure system to carry out the three stages of exposure, washing out and post-exposure.

The normal technique for making photopolymer printing plates for hand stamps, or flexography, is as follows: a masking element (in practice a photographic negative) is placed on a horizontal glass support of an exposure unit (i.e. a device for irradiating the photopolymer with curing radiation). A transparent plastics cover sheet is placed over the masking element and, optionally, any remaining air is evacuated from between the cover sheet and the negative. A containment wall, usually made of foam tape is, laid on the cover sheet to form a reservoir or tray for liquid photopolymer. (From a technical perspective the uncured liquid is arguably better termed “photocurable preparation” but the convenient term “liquid photopolymer” is commonly used in the trade and is also used in this specification).

Liquid photopolymer is then poured into the tray defined by the containment wall to substantially fill the reservoir to its top. Indeed, it is preferably filled sufficiently for a convex meniscus to rise above the containment wall as any overfilled polymer will be forced over the containment wall, whereas an underfilled reservoir would produce a thin plate of poor image. Any entrapped air bubbles are then removed. A semi-rigid backing sheet, which is coated to adhere to the cured polymer, is then carefully placed over the liquid.

An upper radiation source (the “lid” of the exposure unit) is then closed down onto the backing sheet. The uncured photopolymer is then irradiated from above, to form a continuous cured polymer layer supporting the printing surface and from below, for imagewise curing of the photopolymer to form the printing surface.

The cured plate is removed and uncured resin is washed out from the unexposed areas.

The plate is then immersed in a water bath containing dissolved salts and post-exposed (i.e. irradiated again) to make the surface dry to touch. When dried, the plate is ready for printing.

The use of a backing plate which is semi-rigid is regarded as indispensable for two purposes:

a) to exclude air from the reservoir, since it would be difficult or impossible to do this reliably with a fully flexible thin sheet; and

b) to provide the plate, when cured, with the necessary strength and stability to stop premature disintegration during its use as a hand stamp plate or a flexographic printing plate.

The technique of pouring liquid into a reservoir is universally used, notwithstanding that it is difficult to fill the reservoir correctly and that the use of such liquid is difficult, messy and can represent a health and environmental hazard. It is not surprising that attempts have been made to provide the liquid resin in a sealed package, therefore, but none of these attempts has met with success.

JP 61041148, published on 27 Feb. 1986, addresses the problem of the intrusion of air bubbles into the resin and the difficulty of pouring the correct amount of resin into the reservoir. JP 61041148 proposes to solve these problems by sealing a prescribed amount of a photosensitive resin inside a flat container which has transparent walls. The specification alleges that this eliminates concern regarding the presence of air bubbles.

The container of JP 61041148 contains two walls: the first of these comprises a transparent flexible synthetic resin film with an outer face which is contacted with an imaging medium, such as a photographic negative, and which is designed to be detachable from the imaging medium, and whose inner face is arranged to be detachable from the sealed photosensitive resin following curing by exposure; the second of the container walls, on the other hand, is formed from a transparent flexible synthetic resin film which is designed to be adhesive to the cured photosensitive resin. The films forming the two walls are formed to the desired size, then superposed to form the container, a suitable inlet being retained. The required amount of the photosensitive resin is then poured into the container by means of the inlet, a reduced pressure filling device being used to ensure the absence both of air bubbles and of any air gap between the container wall and the resin. The inlet edge of the container is then tightly sealed by melt deposition to form the desired resin holder, which may then be irradiated through a photographic negative to cure the resin in the image areas.

It is noted that the method of JP 61041148 incorporates the use of a container wall comprising a synthetic resin film which is specifically designed to adhere to the cured photosensitive resin so that, following removal of the uncured resin in the non-irradiated areas, the plate comprises the imaged, cured resin attached to the adherent film which, thereby, serves as a backing sheet for the printing plate. This is in accordance with the accepted practice in the platemaking art, wherein it is universal for a stiff backing sheet to be used, the backing sheet being caused to adhere to the photopolymer when it is cured to provide a support for the plate formed on curing the photopolymer.

In the Japanese patent specification, the film which forms the backing sheet comprises a chlorinated, or chlorosulphonated, polyalkylene resin. The use of such materials would, however, be impractical due to their high cost and difficulty in manufacture. Furthermore, in the technique of JP 61041148 it would be expected that further problems would arise as a consequence of the differences in flexibility, tensile strength, and thermal and other physical properties between these resins and the resins forming the opposing walls of the containers.

However, apart from the particular difficulties associated with a backing sheet in the form disclosed in JP 61041148, there are clearly potential disadvantages generally associated with the use of such components in platemaking. It is necessary, for instance, that the backing sheet material should be selected such that adhesion occurs between the backing sheet and the photopolymer resin after curing, and that the adhesion should be strong enough to withstand the harsh conditions associated with printing operations without risk of detachment. Furthermore, the requirement for the backing sheet to display a certain level of strength and rigidity has clear implications in terms of cost.

The technique described in JP 61041148 has apparently never been commercialised. In this respect, the skilled person would have considered it to suffer from two technical problems. Firstly, the specification asserts that the method “eliminates” air bubbles. It is known in the liquid packaging industry that it is difficult to eliminate air bubbles unless the packaging is overfilled or steps are taken to avoid contamination with air bubbles, for example via the use of a vacuum system; the claimed technique appears to offer no advantages over the known art in this respect. Secondly, the method involves the thermosealing of dissimilar plastics sheets, one of which is a relatively expensive chlorinated film.

The thermosealing of dissimilar sheets is always avoided wherever possible because the different coefficients of thermal expansion will give rise to a somewhat distorted product.

Moreover, the different physical properties of the two films are liable to result in differential stretching and flexing of the opposed faces, again leading to distortions in the finished package and hence likely distortions in the cured plate.

EP-A-0607 106 (De Caria) describes a process for making printing plates from photosetting resin. De Caria describes how plates for many printing processes are currently made from photopolymer, substantially as taught previously in this present application, before describing a process for making such generic printing plates by a method which involves pre-packing the liquid photopolymer. As taught in claim 1 of De Caria, the liquid photopolymer is pre-packed in an envelope shaped as a flat pocket or bag and subjected to imagewise curing.

A backing sheet is indispensable for the system described by De Caria, as a generic printing plate includes flexography in its applications and accordingly requires of necessity a backing sheet for strength. Further, De Caria describes and illustrates a system in which the continuous polymer support layer is pre-cured, prior to imagewise curing of the printing surface; such a system requires the polymer support layer to adhere to the envelope, otherwise the support layer will float free in a pool of uncured polymer (i.e. liquid photosetting resin).

De Caria additionally describes that a step common to all the described procedures is that, after sealing of the envelope, rollers are run along the envelope surface to push any remaining air bubble towards a needle or the like, with which the envelope is pierced to release the air. The resulting hole is closed by a drop of glue or in another suitable way. Manifestly, this procedure is inconvenient and the closed hole will be at risk of leaking as well as likely to create a blemish if present on the top (image) surface.

No system for making hand stamps using pre-packaged liquid photopolymer has been commercialised, despite the want of such a system.

### SUMMARY

In summary and without limitation, one aspect of the invention relates to a method for forming a package comprising a sachet containing a curable liquid polymer from which a printing plate for a hand stamp is to be formed. The package (filled sachet) is itself novel and included in the invention. The application describes in another aspect how this filled sachet (or any other filled sachet) can then be inserted in a novel exposure unit to expose it to UV radiation to produce a cured photopolymer plate, the exposure unit itself forming a further aspect of the invention. The application then describes a novel method for surface-treating the cured plate to enable it to be dry post-exposed in, typically, of the same exposure unit. This technology combines the post exposure process with the exposure process without requiring a water bath.

Selected aspects and embodiments of the present invention are set forth in the claims.

### BRIEF DESCRIPTION OF THE DRAWINGS

Selected aspects of the invention are illustrated by way of example only in the schematic drawings, in which:

FIG. 1 is a perspective view of a cassette of the invention and an exposure unit of the invention, showing certain internal features of the latter;

FIG. 2 is a side view the cassette of FIG. 1;

FIG. 3 is a face view of the cassette of FIG. 1; and

FIG. 4 is a schematic cross section through the exposure unit of FIG. 1.

### DETAILED DESCRIPTION OF THE PREFERRED EMBODIMENTS

The Photopolymer Package

The package of the present invention consists of a sachet and a photocurable preparation in the sachet. The package is exclusively for use in making hand stamps and is further characterised by the absence of any element to form a backing sheet. The invention marks a radical departure in photopolymer plate technology in showing that high performance printing plates may, in the case of hand stamps, be obtained by using such a package.

The package may be made by a process wherein a sachet is filled with a curable liquid resin in the absence of a future backing sheet, after which the sachet is irradiated to cure the resin, the outer walls of the sachet are removed, and the contents are washed to remove uncured resin in non-irradiated areas. In this way, it has been possible to provide a device for forming a printing plate (for a hand stamp), and a method for forming the device, which fly in the face of the hitherto accepted technology in dispensing with the use of a backing sheet and thereby offer significant advantages over known processes in terms of simplicity, efficiency of production, and cost.

The preferred mode of forming the photopolymer package according to the invention envisages the introduction of photopolymer into the sachet, this then being allowed to settle, causing the sides of the sachet to distend slightly after filling, such that the sachet is not completely full; a vacuum is then applied to draw the sides of the sachet together above the photopolymer surface, and the sides are then sealed to each other at this region where they are drawn together. This technique, therefore, does not rely on overfilling the sachet. The empty sachet may optionally be formed as an envelope, from a sheet or sheets of material, as the first stage of the manufacture of the photopolymer package. Preferably, however, it is supplied as a pre-formed pouch, which is then filled with the photopolymer prior to sealing. In either case, the empty sachet, which is itself an aspect of the invention, typically comprises a rectangular package, sealed on three sides, with the fourth side open to allow for filling of the sachet.

The present inventor has also shown that, in the preparation of hand stamp printing plates, the presence of a small amount of residual air in sachets prior to curing is not significantly detrimental to the properties of the printing plates, even when the backing plate is dispensed with. This is believed to be due to the fact that, when the filled sachet is placed horizontally on an exposure unit, and despite the viscous nature of the photopolymer liquid (photocurable preparation), the air bubbles can rise to the surface of the liquid so that, when the sachet is imagewise irradiated from the underside, the bubbles are cured into the back side of the plate and not its printing surface. Small imperfections in the back side of the plate are of no great consequence in the case of hand stamps.

The photopolymer packages of the invention may conveniently be irradiated in an upright configuration, i.e. with the image surface and back surface oriented in upward planes, and in this case bubbles will migrate to a region which will become the edge of the cured plate and where they will not have significantly deleterious effect.

The plates remain adequately stable even in the absence of a backing sheet, which the industry has previously regarded as indispensable. Thus, it is possible to envisage a process wherein a sachet is filled and subsequently sealed without any requirement for additional procedures for the removal of air bubbles. In the preferred method for performing the invention, bubbles are minimised (and in many cases visible bubbles are avoided) by filling the sachet under vacuum, preferably not a high vacuum though as otherwise the liquid photopolymer tends to foam.

The development of the invention has resulted at least in part from an appreciation that the assumptions of the prior art were not accurate. Hitherto, it has been assumed that the tendency for air to be trapped within a sachet would inevitably result in serious difficulties since, if the photopolymer were to cure with the air still trapped inside the sachet, the resulting plate would be pockmarked with air pockets, and thus have a damaged printing surface as well as imperfections which could lead to inherent weaknesses in the plate, with a consequent deleterious effect on plate performance notwithstanding the reinforcing backing sheet.

However, the present invention also envisages a process wherein suitable selection of the plastics material from which a sachet is formed allows for the introduction of liquid photopolymer into the sachet in an amount in excess of that required to fill the sachet, the sachet then being sealed to form a bubble-free package despite the presence of the excess photopolymer in the region in which the seal is to be formed. This is possible because the plastics material is capable of thermosealing in these circumstances, and the technique thereby circumvents laborious procedures associated with the removal of trapped air from the sachet, since the sachet may be sealed in the knowledge that the overfilling procedure will have ensured that no air remains trapped therein.

Thus, it can be seen that the present invention allows for the use of a variety of filling methods for the sachet and, in the absence of a backing sheet which had previously been indispensable, these methods are not associated with the technical complexities and difficulties encountered in the prior art.

Thus, the invention provides in a first aspect a photopolymer package for use in making a hand stamp plate, the package consisting of a sealed sachet and a curable liquid photopolymer preparation contained in the sachet, the sachet being formed of material which is releasable from the cured photopolymer. After the photopolymer has been cured, therefore, the sachet is stripped from the cured resin to provide resin plate without a backing sheet. In other words, a package which consists essentially of resin and sachet material which is releasable from (can be stripped by hand from) the cured resin is devoid of any structure to form a future backing sheet.

Preferably, the sachet is produced from a pouch which is pre-formed from two rectangular sheets of material; one is placed on top of the other and the assembly is sealed on three sides, preferably by thermosealing, leaving a pouch, sealed on two sides and at the bottom, with one open side at the top, forming a mouth through which filling with photopolymer can take place. (The terms “top”, “bottom” and “side” refer here to the future orientation of the sachet during filling). The walls of the sachet are formed of the same material. The pouch may also be pre-formed from a single sheet of material, the sheet being folded in half and the two sides adjacent the fold being sealed, preferably by thermosealing, leaving the side of the pouch opposite the folded side open for filling with photopolymer.

Alternatively, the sachet may comprise a four-sided form-fill-seal sachet, wherein an envelope, sealed on three sides, is formed from a sheet or sheets of material immediately prior to filling with photopolymer, the fourth side being sealed to provide the finished sachet following completion of the filling operation.

The walls of the sachet are made of plastics material. Whilst a wide range of such materials is suitable for use in the context of the present invention, it is necessary that the material selected should possess two properties inherent in photopolymer systems: in the first instance, it is clearly a requirement that the material should allow for a high degree of transmittance of curing radiation, e.g. UV-radiation and in normal practice actinic radiation, since the photopolymer in the package is normally UV-cured; secondly, the radiation which is transmitted should pass through the material without being seriously diffracted. Further, it is desirable that the material should have a high degree of resistance to creasing, otherwise the sachet will have to be handled with great care.

Conveniently the plastics material is a polyolefin material or a polyolefin laminate. The polyolefin is typically polyethylene or a polyethylene copolymer or polyethylene blend. Nylons® and other normal polyamide materials are found to diffract light, but orientated polyamides (OPA) do transmit light and may be used. Preferably, the plastics material (plastics film) is a laminate. Optionally, the plastics film may be surface treated, but it is preferred that untreated plastics material should be employed. Particularly favourable results have been achieved using a polyethylene/polyethylene terephthalate laminate material. In such commercially available materials, the layers of the two plastics are bonded together by means of an adhesive interlayer.

A further parameter which must be considered in relation to the three properties specified above is the thickness of the plastics material. Thus, it is found that increasing thickness leads to improvements in terms of crease resistance, but is also associated with reductions in light transmittance. Conversely, thinner films give a high level of light transmittance, but show an increased tendency towards creasing.

Consequently, a preferred range of thickness for any given plastics material should be established, in order that all aspects of performance may be optimised. It has also been found that for optimum performance, the larger the sachet is, the thicker the film should be. This can been seen as, in effect, achieving a constant ratio of film thickness to film area, maintaining the rigidity of the package at a constant level. However, very thick films provide a stronger apparent adhesion to the cured film than thinner films, and this has proved to be a problem with thinner plates when removing the film, because the plate tends to pull away in parts not in whole. Whereas thicker films (typically at 160 μm and above) can be used with thicker plates (typically above 4 mm in depth), when used on thinner plates they exert too much force when being removed. The industry standard thickness of plate is 2.3 mm, and experiments indicate that, for commercially acceptable performance, the maximum thickness of film that can be used with such plates is 90 μm, or thereabouts.

More generally, it may be stated that the sachets of the invention are desirably made of plastics material that has a thickness of from 30 to 180 μm, and more preferably of from 70 to less than 110 μm. Hence, for the polyethylene/polyethylene terephthalate laminate material previously mentioned, it has been found that thicknesses above about 180 μm are associated with unacceptably low light transmittance levels and a bad image, whilst creasing becomes a major problem when the thickness falls below around 30 μm. Preferably, in particular for a sachet of A5 size, the laminate is at least 60 μm, and more preferably at least 70 μm, thick. More usually, it is between 75 and 90 μm thick, in particular but not exclusively for A5 size sachets. Optimum levels of performance for a sachet of this size appear to be achieved with this particular plastics material when it comprises a 70 μm film of polyester laminated to a 12 μm film of polyethylene terephthalate, giving an overall thickness in the region of 82 to 85 μm. At this thickness, the level of light transmittance is found to be approximately 85%. It is believed that the thickness of inter lamina adhesive layers is typically about 3 μm.

The liquid photopolymer preparation may comprise any readily available photopolymer preparation of the type which will be well known to the skilled person. Advantageously, a preparation of relatively low viscosity is used, as this aids filling. Typical liquid photopolymers may include, for example, unsaturated polyester resins, unsaturated polyurethane resins, unsaturated polyamide resins and unsaturated poly(meth)acrylate resins, for example polyether urethane polymers, or polyether polyester urethane copolymers such as polyether polyester urethane methacrylate polymers.

The liquid photopolymer will in commercial practice include a photoinitiator in the known way. Particularly suitable photoinitiators are organic carbonyl compounds and these include, for example, unsubstituted or substituted benzophenones such as benzophenone, 4-bromobenzophenone, 4,4′-dichlorobenzophenone, 4-4′-dimethoxybenzophenone, 4-methylbenzophenone, 4-hydroxybenzophenone, 3,5-dihydroxybenzophenone, 4-phenylbenzophenone and deoxybenzophenone; unsubstituted or substituted acetophenones such as acetophenone, 4-methylacetophenone, 3,5-dimethylacetophenone, 4-methoxyacetophenone, 2-chloroacetophenone, 4-chloroacetophenone, 2-chloro-3-nitroacetophenone, 2-chloro-5-nitroacetophenone, 2,6-dimethoxyacetophenone, 4 -hydroxyacetophenone, α-phenylacetophenone and α,α-dichloroacetophenone; unsubstituted or substituted aromatic ketones such as deoxybenzoin, phenyl naphthyl ketone, benzoin methyl ether, benzoin ethyl ether, benzoin n-propyl ether, benzoin isopropyl ether, benzoin n-butyl ether, benzoin isobutyl ether, benzoin t-butyl ether and other alkyl ethers of benzoin, and α-diketones such as benzil; and various quinone compounds such as p-benzoquinone, 2,5-dimethyl-p-benzoquinone, 2,6-dichloro-p-benzoquinone, 9,10-anthraquinone, 2-methyl-9,10-anthraquinone, 2-ethyl-9, 10-anthraquinone, 2-bromo-9,10-anthraquinone, 2-ethyl-5,6,7,8-tetrahydroanthraquinone, 1,4-naphthoquinone, 2,3-dichloronaphthoquinone, 2,3-dimethyl-1,4-naphthoquinone, 2-ethyl-1,4-naphthoquinone, phenanthraquinone and 1,2-naphthoquinone. Furthermore, the photoinitiator may comprise a mixture of compounds, for example a mixture of one or more of the above named compounds.

Additionally, the resin preparation may contain any one or more of a range of further performance-enhancing additives including, for example, esters of acrylic or methacrylic acid, stabilisers, defoamers, dyes and high molecular weight fatty acids; the fatty acids, for example myristic acid, are particularly effective in ensuring a dry, tack-free surface after post-curing of the washed plate. However, it is found that the presence of myristic acid in the photopolymer package can result in a degree of cloudiness; whilst this is not detrimental to the performance of the package, it is considered to be cosmetically undesirable, and it is contemplated that the presence of this material could be avoided.

According to another aspect of the present invention, there is provided a method for forming a photopolymer package for use in making a hand stamp, the method comprising filling an envelope with a photocurable liquid polymer and sealing the envelope to form such a package consisting of a sealed sachet and said polymer, the envelope being made of material which is releasable from the cured photopolymer.

A first embodiment of this aspect of the invention envisages a method for forming a photopolymer package for use in making a hand stamp which comprises: providing an envelope which comprises a pre-formed pouch to contain the photocurable liquid polymer, the pouch being formed from a sheet or sheets, both of which can be released from the cured photopolymer, and having a mouth formed between adjoining portions of the sheet or sheets to receive the liquid curable polymer; introducing the photocurable liquid polymer into the pouch by way of the mouth of the pouch to fill the pouch to a level less than its capacity; applying a vacuum to draw the sides of the pouch together above the level of the photopolymer; and then sealing the adjoining portions of the sheet or sheets together to form a package consisting of a sealed sachet and said polymer.

After filling the pouch with the photopolymer, the mouth of the pouch is sealed by suitable means, preferably by thermosealing.

A second embodiment of this aspect of the invention envisages a method for forming a photopolymer package for use in making a hand stamp, the method being a form-fill-seal process which comprises: forming an envelope to contain the photocurable liquid polymer from a sheet or sheets, both of which can be released from the cured photopolymer, the envelope having a mouth formed between adjoining portions of the sheet or sheets to receive the liquid curable polymer; introducing the photocurable liquid polymer into the envelope by way of the mouth of the envelope to fill the envelope; and then sealing the portions of the sheet or sheets together to form a package consisting of a sealed sachet and said polymer. The invention thereby includes a method in which a photopolymer package for use in making a hand stamp is made by a method consisting essentially of a form-fill-seal technique using a sheet or sheets, neither of which adheres to the cured resin.

A third embodiment of this aspect of the invention envisages a method for forming a photopolymer package for use in making a hand stamp, the method being a form-fill-seal process which comprises: forming an envelope to contain the photocurable liquid polymer from a sheet or sheets, both of which can be released from the cured photopolymer, the envelope having a mouth formed between adjoining portions of the sheet or sheets to receive the liquid curable polymer; introducing the photocurable liquid polymer into the envelope by way of the mouth of the envelope to fill the envelope beyond its capacity; and then sealing the portions of the sheet or sheets together through the excess photopolymer to form a package consisting of a sealed sachet and said polymer.

When overfilling is used, we have found standard polyolefin sheeting workable. However, the mouth portions of the sheet or sheets may be specially selected to facilitate thermosealing together despite the presence between those portions of fats present in commercial liquid photopolymer preparations, as a result of overfilling the envelope. The presence of these fats can have a deleterious effect on the thermosealability of the mouth portions if standard polyolefin sheeting is used. The fats are those present in a typical curable liquid photopolymer such as an unsaturated polyester urethane methacrylate and/or polyether polyester urethane methacrylate polymer, ethylenically unsaturated monomers such as esters of acrylic acid and/or methacrylic acid and a photopolymerisation initiator. A suitable adapted transparent plastics sheet material is Rocklid (Trade Mark) or Rockseal-O (Trade Mark) of Rockwell Solutions Limited. Rockseal-O in particular is specially designed to thermoseal through fats and oil.

In our method, despite the presence of the photopolymer on the inside surface of the sheet portions forming the mouth, the sheets or sheets seal together because they have been specially selected to be thermosealable despite the presence of fats.

A fourth embodiment of this aspect of the invention envisages a method for forming a photopolymer package for use in making a hand stamp, the method being a form-fill-seal process which comprises: forming an envelope to contain the photocurable liquid polymer from a sheet or sheets, both of which can be released from the cured photopolymer, the envelope having a mouth formed between adjoining portions of the sheet or sheets to receive the liquid curable polymer; introducing the photocurable liquid polymer into the envelope by way of the mouth of the envelope to fill the envelope to a level less than its capacity; applying a vacuum to draw the sides of the envelope together above the level of the photopolymer; and then sealing the portions of the sheet or sheets together to form a package which consists of a sealed sachet and said polymer.

As in the case of the pre-formed envelope, formation of the envelope as a stage in the form-fill-seal procedure may involve the use of either one or two sheets of plastics material, but envelopes formed from two sheets are preferred. In the case wherein the envelope is produced from a single sheet of material, the sheet is folded in half and the two sides adjacent the fold are sealed, preferably by thermosealing, leaving the side of the envelope opposite the folded side open for filling with photopolymer. When two rectangular sheets of plastics film are employed, the sheets should be of equal size; one is placed on top of the other and the assembly is sealed on three sides, again leaving an envelope with one open side, forming a mouth through which filling with photopolymer can take place. Sachets formed from a single rectangular sheet of material include three sides which are sealed, the fourth side comprising a fold, whereas the preferred sachets, formed from two rectangular sheets of material, are sealed on all four sides.

The liquid photopolymer is introduced into the open mouth of the pouch or envelope for example by pouring or injecting. The photopolymer may be heated to around 50-60° C. to decrease its viscosity and thereby facilitate greater ease of transfer to the pouch or envelope; removal of air and other gases from the photopolymer whilst under vacuum is also made easier by raising the temperature in this way. The sealing operation may then take place, preferably using any of the standard thermosealing techniques well known to those skilled in the art.

A preferred method comprises forming a photopolymer package for use in making a hand stamp wherein a pouch is pre-formed from two sheets of identical plastics film. Production of the sealed sachet forming the photopolymer package from the said pouch may then be achieved by either manual or automated means. Thus, the pre-formed pouch may be manually filled by pouring or injecting the photopolymer, or a pump or gravimetric/peristaltic system may be used, and the pouch can then be sealed by means of a heated bar in a vacuum chamber; commercially available vacuum packing apparatus, such as the Multivac® C400, may conveniently be used for the latter purpose. Typically, the pouch is held under vacuum for 1-2 minutes to allow the sealing process to be completed.

Alternatively, an automated procedure may be employed, wherein a succession of pre-formed pouches are mounted in line, vacuum filled (usually individually) with photopolymer, then either individually vacuum sealed by application of a local vacuum to each envelope in turn or, more preferably, bulk sealed by introducing a multiplicity of filled envelopes into a vacuum chamber prior to performing the sealing operation. In any event, the photopolymer is allowed to settle in the pouch, causing the sides to bulge slightly after filling, prior to drawing together the adjacent sides at the open end and sealing, preferably by thermal means.

During the vacuum application stage of these procedures, when the adjacent sides of the sachet are drawn together prior to sealing, it has been observed that significant foaming of the photopolymer is prone to occur if the vacuum that is applied is too great, typically in excess of 700 mbar. As this foaming effect is deleterious it is preferable to keep the vacuum level low, sufficient only to remove air above the resin but not sufficient to cause foaming. For practical reasons, it is not realistic when using high vacuum to continue the procedure until foaming totally ceases since this would be excessively time-consuming.

The invention includes the ready-to-fill envelopes formed during the manufacturing process, for example comprising plastics sheet material having three sealed edges arranged as three sides of a rectangle and a mouth to receive liquid photopolymer. More particularly, but without limitation, there is provided a receptacle for use in forming a photopolymer package, comprising an envelope of plastics sheet material, the plastics sheet material having the characteristics that it is substantially transparent to actinic radiation and if contacted with photosetting resin during curing of same it can thereafter be released from the cured resin, the envelope having opposed major surfaces, each major surface having three edge regions which are arranged as three sides of a rectangle generally of hand stamp size and are sealedly connected to an opposed edge region of the other major surface, and the region of each major surface which is located in the position of the fourth side of the rectangle, between end regions of two of said three edges, defining together with an opposed region of the other major surface a mouth to receive liquid photosetting resin.

In one embodiment the receptacle is made of two separate sheets of plastics material and the sealedly connected edge regions are connected together by heat sealing.

In another embodiment, the receptacle is made of a single sheet of plastics material and the sealedly connected edge regions are at one said side connected as one piece through a fold, the sealedly connected edge regions at the remaining two of said three sides being connected together by heat sealing.

Also included in the invention is a receptacle for use in forming a photopolymer package, comprising a substantially rectangular, generally hand stamp-sized envelope of one or more plastics materials, the or each plastics material having the characteristics that it is substantially transparent to actinic radiation and if contacted with photosetting resin during curing of same it can thereafter be released from the cured resin, the envelope having opposed major surfaces and the major surfaces each having four edge regions, three edge regions of each major surface being sealedly connected to an opposed edge region of the other major surface and the fourth edge region, together with an opposed edge region of the other major surface, defining a mouth to receive liquid photosetting resin.

As previously discussed, a wide variety of thermoplastic and heat-sealable materials may be used for the formation of sachets by the methods envisaged by the present invention, suitable examples including polyethylenes and various laminates. The nature of the material determines the particular heat-sealing technique which is employed, but these will generally involve the application of heat and pressure. Many thermoplastics are sealed by means of impulse sealing, wherein a charge of electricity heats a wire to a pre-established temperature, and no specific tooling pressure is required.

The resulting sachet has the advantage over materials of the prior art that it comprises continuous, uniform walls on each side, since the invention requires neither a backing sheet nor treatment subsequent to sealing to release air from the envelope and, consequently, no hole is introduced into any part of the sachet. The absence of such defects at this stage has advantages both in terms of storage life and the subsequent performance of the plate in use.

As previously observed, in addition to the use of a pre-formed pouch for the production of the photopolymer package, the invention also envisages the use of a form-fill-seal technique to produce an envelope suitable for such purpose. Two principal form-fill-seal techniques are known, namely horizontal form-fill-seal (HFFS) and vertical form-fill-seal (VFFS). HFFS is used for a variety of products and, as the name suggests, involves the material forming the sachet travelling in a horizontal plane. Typically, the material is dispensed from a roll and is pulled forward and folded to form a tube, whereupon the side opposite the fold is heat sealed. Subsequently, the ends are sealed, the back seal on one pouch forming the front seal on the next, and the resulting sachet is cut free. Filling of the sachet is achieved by cutting it open and inserting the relevant product by top-filling, following which the sachet is resealed.

Clearly, the cutting open and resealing procedure generally associated with HFFS represents a drawback of the technique, and it would be advantageous if the sachet could be filled prior to final sealing. This is possible by means of VFFS, wherein a web of material is driven or pulled down vertically, wrapped round a collar to form a tube and the side opposite the fold is sealed, as with HFFS. Alternatively, the web of material may be cut in two and the two strips in generally vertical orientation are then presented face to face with both sides requiring sealing in order to form the requisite tube. Thereafter, the bottom end of the tube, which will form one end of the sachet, is sealed. Filling of the sachet with the relevant product then takes place, after which the top of the sachet is sealed, this seal simultaneously forming the bottom of the next sachet, with the lower formed and filled sachet being cut free from the upper sachet at this stage. Conveniently, the filler device (fill tube) may be mounted directly above the tube forming section.

It has been found that commercial automatic VFFS sachet packaging machines are suitable for the formation of photopolymer packages in accordance with the foregoing method. In particular, those machines which cut a web of material into two sheets, then bring these sheets face to face and seal them together, have been utilised with success.

Thus, a reel of plastics material is fed through the machine until it reaches a blade which slits the material into two equal sections. The separate sections are split off in opposite directions at 90° to the reel through a film divider unit. The inner sides of the two sections of plastics material are then positioned to vertically face each other and brought together in order that the bottom and sides may be heat sealed to form an open sachet.

The dosage of photopolymer required to be present in a single sachet is then introduced into the sachet by means of an appropriately located fill tube connected to a pump or gravimetric/peristaltic system. The operation is carried out under vacuum in order to eliminate air although, as previously disclosed, it is not essential to the performance of the invention that all air should be removed in every case, which is not true of the methods of the prior art.

Following the initial dosing procedure, the top seal of the sachet is formed by heat sealing, this seal also forming the bottom seal for the next sachet in the continuous web of plastics material. The side seals of the next sachet are formed at the same time, thereby beginning the cycle again, the next sachet being filled in the manner previously described. The individual sachets are then cut off from each other by means of a slitter.

Thus is provided a continuous method for the production of photopolymer packages according to the method of the invention.

The automatic sachet packaging machines of this type may be used to pack into sachets viscous liquid products in volumes from 1 ml to 250 ml. The optimum dose of photopolymer for the purposes of the invention is determined by the size of the photopolymer package which is to be manufactured.

In general, sachets having a length of between 32 mm and 400 mm, and a width in the range from 25 mm to 280 mm may be produced using these automatic sachet packaging machines, and the precise dimensions may be tailored to the proposed end use of the hand stamp, as will be discussed at a later stage. A wide range of plastics materials is suitable for use with such machines, but the preferred thickness is from 30 to 180 μm.

However, the use of pre-formed pouches allows for the removal of such constraints with regard to the dimensions of the envelopes and it is possible to envisage the use of a range of envelopes, tailored in size to the exact requirements of the eventual end-user. Thus, the preferred method of manufacture allows for complete flexibility in the selection of package size.

Following filling and sealing, the sachet is irradiated to cure the photopolymer, the walls of the envelope are removed and the remaining material is washed to remove uncured photopolymer and leave the plate which is to form the printing head for a hand stamp. These steps are described more fully below, by way of non-limiting illustration.

Thus, another aspect of the present invention provides a method for the preparation of a plate for use as a hand stamp, the method comprising:

(a) providing a photopolymer package of the invention;

(b) imagewise irradiating the package;

(c) removing the material forming the walls of the package;

(d) washing the resultant cured plate to remove non-irradiated material;

(e) post-exposing the washed out plate to remove surface tackiness; and

(f) drying the plate.

The post-exposure may optionally be performed dry, for example as described below under the heading ‘The Dry Post Exposure Surface Treatment Method’.

Irradiation of the package is carried out by exposure of the sachet containing the photopolymer to curing radiation through a masking element (usually a photographic negative) which selectively blocks areas from irradiation. The future back surface is exposed to substantially uniform radiation of an intensity which, during the exposure time, cures only a surface region of the polymer to form a continuous back surface which will play no direct part in printing operations, but does provide a surface by means of which attachment to a device such as a handle may be effected, thereby enhancing ease of use. Meanwhile, the future printing surface is irradiated while a masking film (e.g. a photographic negative) is interposed between the wall of the sachet and the radiation source, such that the photocurable liquid polymer in the bottom region cures selectively in areas where the masking film allows more transmission of radiation. The radiation used is usually actinic radiation.

The packages of the present invention offer a further advantage over the prior art during exposure, in that it is not necessary for air to be evacuated from the space between the masking element and the sachet whilst irradiation is taking place. Previously, it had been found that sharpness of image formation and efficiency of curing was adversely affected by the presence of even small pockets of air in the space between the masking element and the containing wall of the envelope holding the photopolymer; this has required the evacuation of this space prior to exposure. It has been found that, when the user makes a plate using a package of the invention, the quality of the image is superior to that made by manual assembly of the components as described earlier. It is not known exactly why this should be, but it is assumed that, because in commercial practice the sachet contains a metered quantity of liquid resin (generally the exact quantity of resin is supplied pre-weighed), the package always makes perfect contact with the negative.

As has already been stated, following irradiation of the sachet and its contents, it is necessary to remove the material forming the walls of the sachet in order to reveal the cured resin formed on irradiation of the curable preparation. Removal of this material may be achieved with relative ease by simply cutting the material and removing the sheet of cured photopolymer.

The front surface of the resulting cured photopolymer plate has liquid photopolymer preparation in unexposed areas. This liquid photopolymer may then be removed by washing the plate; the existing practice for performing this act is either by simply using detergent under a running tap or by using an automated wash out unit providing a spray or jet of aqueous liquid. The wash out unit normally comprises a rotary drum and clamp devices to hold the plate to the drum, with the back surface against the drum, so that the liquid photopolymer is exposed. The wash out unit also has spray apparatus, normally comprising a multiplicity of spray heads, arranged to spray wash out liquid onto the clamped plate while the drum rotates so as to wash liquid photopolymer out of the plate. Alternatively the plate is immersed in a bath whilst being in contact with rotational scrubbing brushes that scour the surface of the plate. The wash out liquid comprises an aqueous medium containing a surfactant and preferably an anti-foaming agent. The wash out liquid should be free of significant quantities of organic solvent in order to avoid damage to the washed plate.

The surfactant is usually added to water to form the wash out liquid in an amount of from 3% to 5% by weight based on the amount of water. Any surfactant can be used in a suitable concentration, typical examples being alkyl sulphates, (e.g. lauryl sulphate), dialkyl sulphosuccinates (e.g. sodium dioctyl sulphosuccinate), triethanolamine alkyl sulphates, polyoxyethylene alkylphenylether sulphonic acid sodium salts and polyoxyethylene alkylbenzene sulphonic acid triethanolamine salts. If desired, the surfactant may comprise a mixture of two or more surfactant compounds.

The wash out liquid may contain a hydrogen abstraction compound as described in GB-A-2356712 and U.S. Patent Application No. 60/167,685, the content of which is incorporated herein by reference; however it is preferred that, instead the technique described below under the heading “The Dry Post Exposure Surface Treatment Method” is used. The wash out unit may be employed under conventional conditions, for example the wash out liquid may be employed at room temperature (ambient temperature) or at an elevated temperature of, for example, up to 50° C., e.g. about 40° C.

A plate for use as a hand stamp and obtainable using a method of the invention, i.e. having the characteristics of a plate obtained using a method of the invention, itself forms an aspect of the invention. Accordingly, the invention includes a photopolymer plate for use as a hand stamp and not comprising a backing sheet.

Another aspect of the present invention resides in a hand stamp for use in the stamping of documents and comprising a plate of the invention.

The hand stamps of the invention may be produced in a variety of sizes according to their proposed use. Most conveniently, however, the stamps are designed to be not greater in size than the most common standard paper sizes, such as A3. Thus, the largest size stamps would typically not exceed the following dimensions:

| | | |
|---|---|---|
| A3 | 16½ inches × 11⅔ inches | (42 cm × 29.6 cm) |
| Foolscap | 13 inches × 8 inches | (33 cm × 20.3 cm) |
| US | 11 inches × 8½ inches | (27.9 cm × 21.6 cm) |

As previously observed, the present invention allows the stamps to be tailored to the exact size required by the user by manufacturing the sachets to the desired size. More usually, the sachets will provide a plate whose dimensions are smaller than these standard sizes, for example approximately a half (A4), a quarter (A5) or an eighth (A6) of the standard A3 size.

As discussed previously, the present inventor has found that the performance of plates produced using a photopolymer package of the present invention is not deleteriously affected by the presence of small amounts of trapped air or gas in the sachet containing the photocurable liquid polymer prior to curing. Consequently, it is envisaged that photopolymer packages of this embodiment of the present invention may contain such bubbles to a limited extent. However, it is not, of course, necessary that these bubbles should be present, and it is quite possible that at least a number of the packages coming off a production line will, in fact, be free from such bubbles. In the mass manufacture of sachets by form-fill-seal in which the sachets are to be filled at ambient pressure with the precise amount of liquid for complete filling, manufacturing tolerances will inevitably result in a proportion of sachets containing bubbles when they are produced according to the relevant embodiment of the present invention.

Consequently, the present invention includes a multiplicity of photopolymer packages for use in making hand stamp plates, the packages consisting of form-fill-seal sachets containing a curable liquid photopolymer, the sachets being formed of a material capable of being released from the cured photopolymer, a proportion of the packages containing bubbles.

Conveniently, such a multiplicity of packages may be stored or transported by means of boxes or other suitable containers which may, typically, be loaded on one or more pallets for ease of handling.

The Dry Post Exposure Surface Treatment Method

Another aspect of this invention is a new procedure for post-exposing a photopolymer plate to make it dry to touch. This aspect of the invention, although not limited thereto, is particularly suitable for the manufacture of hand stamps. Hand stamp manufacturers tend to operate with very little automated equipment, for example only the largest companies have automated wash out units. A large number of companies do not even have a post exposure water bath, and have to achieve a tack free surface by dusting the plate with talcum powder. This quickly clogs the printing relief and has to be replenished regularly.

Following the washing out process, the front surface of the washed plate is tacky in areas previously covered by uncured photopolymer and is typically post-exposed to curing radiation to remove tack. Post-exposure typically involves exposure of the plate to ultra-violet light, generally at a wavelength within the range of from 200-280 nm, and the procedure may be carried out by means of any commercially available post-exposure unit. Post-exposure is traditionally carried out under water, which provides substantially anaerobic conditions, and the water contains dissolved post-exposure salts to prevent the small amount of dissolved oxygen inhibiting curing; the post-exposure salts in practice include sodium sulphite (an oxygen scavenger).

As an alternative, however, the post-exposure may be carried out under dry conditions. In this respect, there has previously been devised a dry post-exposure treatment which provides a plate having a smooth, tack free, fine surface finish with the advantage that there is no requirement for a water bath or the required salts. The shelf life of the plate and particularly the ability of the plate to resist UV degradation has also shown to be enhanced by this existing method. This technique has been described in GB-A-2356712. Here a method is described of achieving dry post-exposure by adding a hydrogen abstraction photoinitiator (H-abstraction photoinitiator) as a dispersion in the wash-out. This has great benefits for the large flexographic plate maker who, in using this method, does not need the use of a water bath and salt solution to cure the plate. GB 2356712 cites that its application is the printing of paper for leaflets and booklets and cardboard in the form of boxes and metals. These are the applications of the flexographic printing industry not the hand stamp industry.

As previously stated, GB2356712 is of use only if the user has an automated wash out system in which to add the H-abstraction photoinitiator. This is because, for optimum performance, the concentration of H-abstraction photoinitiator has to be maintained between set limits, GB 2356712 states preferably between 0.3% and 0.6% by weight in the wash out solution. The initiator also has to be in frequent contact with the surface of the plate to effect a symbiotic relationship with the surfactant (typically a substituted amine surfactant such as triethanolamine alkyl sulphate for example). It has been noted that the effect of the water jets of the wash-out liquid during the wash-out process may help drive the dispersed initiator into the resin at a relatively high concentration and to a relatively great depth.

As stated above, most hand stamp manufacturers wash their plates out under running water in a sink. In this case it is not possible to deliver the H-abstraction photoinitiator in any controlled concentration whilst flowing water is running over the plate and out of the sink. It is known that an excess of H-abstraction photoinitiator will impair the printing image. It would therefore be not only very costly, wasteful and potentially harmful to the environment to apply an H-abstraction photoinitiator over the plate whilst washing out under running water, but also very likely that the concentration would at some time exceed the maximum desired of for example, 0.6% (by weight) of the liquid currently in contact with the plate. The obvious solution to the problem would be for stamp manufacturers to use a wash out unit. However, this invention provides an alternative method for achieving a tack free plate whilst maintaining the advantages of using a dry post-exposure system.

Utilising this aspect of invention the hand stamp manufacturer is able to wash out the plate after exposure as normal, dry it and then contact its surface with a liquid containing an H-abstraction photoinitiator, as a developer, onto the printed image prior to post exposing under germicidal lights. In many cases, only the image surface of the plate is contacted with the liquid photoinitiator preparation.

Usually, the liquid containing the H-abstraction photoinitiator is a solution in an organic solvent (such as butyl acetate, for example). In principle, any H-abstraction photoinitiator could be used. These compounds are generally organic carbonyl compounds, and in particular carbonyl compounds having at least one optionally substituted aryl group bonded to the carbon atom of the carbonyl group.

Specific examples of H-abstraction photoinitiators are unsubstituted or substituted benzophenones such as benzophenone, 4-bromobenzophenone, 4,4′-dichlorobenzophenone, 4,4′-dimethoxybenzophenone, 4-methylbenzophenone, 4-hydroxybenzophenone, 3,5-dihydroxybenzophenone and 4-phenylbenzophenone; unsubstituted or substituted acetophenones such as acetophenone, 4-methylacetophenone, 3,5-dimethylacetophenone, 4-methoxyacetophenone, 2-chloroacetophenone, 4-chloroacetophenone, 2-chloro-3-nitroacetophenone, 2-chloro-5-nitroacetophenone, 2,6-dimethoxyacetophenone, 4-hydroxyacetophenone, alpha-phenylacetophenone and alpha,alpha-dichloroacetophenone; unsubstituted or substituted aromatic ketones such as deoxybenzoin, phenyl naphthyl ketone, benzoin methyl ether, benzoin ethyl ether, benzoin n-propyl ether, benzoin isopropyl ether, benzoin n-butyl ether, benzoin isobutyl ether, benzoin t-butyl ether and other alkyl ethers of benzoin; and various quinone compounds such as 9,10 anthraquinone, 2-methyl-9,10-anthraquinone, 2-ethyl-9,10-anthraquinone p-benzoquinone, 2,5-dimethyl-p-benzoquinone, 2,6-dichloro-p-benzoquinone, 2-ethyl-5,6,7,8-tetrahydroanthraquinone, 1,4-naphthoquinone, 2,3-dichloronaphthoquinone, 2,3-dimethyl-1,4-naphthoquinone, 2-ethyl-1,4-naphthoquinone, phenanthraquinone and 1,2-naphthoquinone; and alpha-diketones such as benzil.

Particularly suitable H-abstraction photoinitiators are benzophenone, 4-methylbenzophenone, 4,4′-dimethoxybenzophenone, 4-hydroxybenzophenone, deoxybenzophenone, deoxybenzoin, acetophenone, 2-chloroacetophenone, 4-methylacetophenone, 9,10-anthraquinone, 2-methyl-9,10-anthraquinone, 2-ethyl-9,10-anthraquinone and 2-bromo-9,10-anthraquinone.

In practice the H-abstraction photoinitiator may contain a combination of compounds, for example a mixture of one or more of the above named compounds. A particularly suitable photoinitiator has found to be a mixture of 4-methylbenzophenone and benzophenone in equal parts by weight. This has found to be ideal when in solution in an organic solvent. It has been found that butyl acetate is a particularly suitable solvent. The solvent may comprise a mixture of suitable organic liquids.

Normally, the photoinitiator should not be in an amount exceeding 40 wt % of the solvent/photoinitiator solution, and preferably in an amount not exceeding 30 wt %, and it is preferable for the amount not to be less than 10 wt %; a weight ratio in the region of 15-25% photoinitiator:85-75% solvent is preferable, and most desirably a ratio of about 20% photoinitiator:80% solvent. A lower concentration of H-abstraction photoinitiator tends to leave the plate less dry to touch, an excess of H-abstraction photoinitiator was wasteful and costly. Experiments indicate that spraying any preparation containing a non-negligible percentage of H-abstraction photoinitiator onto the plate has a beneficial effect on its tackiness.

This liquid is ideally delivered in such a manner so as to completely cover the image surface of the plate in a thin, even film. Most preferably the liquid is delivered as a spray. The spray may be contained in a hand operated pump spray bottle or a pressurised aerosol. Alternatively, the liquid may be applied using a brush. For convenience it was found that an aerosol of particles was best delivered evenly and thinly by a pump spray bottle at a distance of about 20 cm from the plate. It was found that if the spray was too close to the plate large droplets formed on the plate and the cured plate was marked by their presence. If the spray was too far away, then the aerosol became excessively lost into the atmosphere. It is important not to flood the printing image with the solution otherwise the image could be attacked by the solvent.

After the liquid has been applied, the plate is allowed or caused to dry, and usually is either oven dried (at low heat) or air dried prior to post exposure.

The invention includes spray apparatus containing a liquid photoinitiator preparation for spraying photoinitiator onto a photopolymer plate. One aspect of the invention therefore includes a device for spraying a washed-out photopolymer printing plate with an H-abstraction photoinitiator preparation, comprising a spray head in fluid communication with a reservoir containing an H-abstraction photoinitiator preparation, the device for example being a hand pump sprayer or an aerosol can.

The invention further includes a solution comprising an organic solvent and an H-abstraction photoinitiator in an amount of from 10 wt % to 40 wt % of the solution.

The Exposure Apparatus

A third part of this invention comprises a new exposure unit specifically designed to take a photopolymer sachet, especially a package of the invention, and preferably for use in conjunction with the dry post-exposure spray. Current exposure units consist of a horizontal glass bed covering a set of actinic radiation emitting tubes (to expose the face or printing surface of the plate), a hinged lid containing a further set of actinic radiation emitting tubes (to expose the floor of the plate) and a set of timers and controls to govern their activity. More sophisticated systems are fitted with a vacuum system to draw the air out from between the negative and the coverfilm.

The present invention provides exposure apparatus comprising an exposure unit having defined therein a space to receive a cassette and, on opposed sides of the space, actinic light sources arranged to irradiate a sachet containing liquid photopolymer when such sachet is in a cassette received in the space. In preferred apparatus, the space is upright, preferably substantially vertical, in use, cassettes being put into and taken from the space via a mouth at the top; for obvious reasons exposure units of this type may be called “toaster-type”.

The apparatus preferably further includes a cassette adapted to be received in the space and comprising opposed rigid plates relatively transparent to actinic radiation and, if necessary for reasons discussed below, to germicidal radiation, the plates preferably being moveable between an open position (of generally relatively large separation) for receiving a sachet containing liquid photopolymer and a photographic negative or other masking element and a closed position (of generally relatively small separation) in which the cassette is received in the space and the opposed plates are positioned substantially in parallel and separated by a selected distance.

The opposed rigid plates of the cassette are normally made of glass. The selected distance between the closed plates substantially corresponds to the thickness of a photopolymer plate made in the exposure unit and the distance may be pre-selected by the cassette manufacturer, i.e. the separation of the closed plates may be invariable. The cassette preferably comprises a base plate which is opaque to the radiation omitted by the exposure unit and is adapted to close the space of the exposure unit when the cassette is fully inserted and prevent any significant emission of potentially harmful radiation externally of the exposure unit.

Preferably, the cassette is for use in making hand stamp plates and thus adapted to hold filled sachets designed for that purpose; most preferably there are used photopolymer packages of the invention. The separation between the closed plates is preferably of from 1.5 mm and 6 mm; in the case of cassettes for making hand stamp plates, the separation is preferably about 2.3 mm (e.g. 2.2 mm-2.4 mm, especially 2.3 mm-2.4 mm).

The opposed rigid plates of the cassette are preferably arranged for pivotal movement of one or both plates, to allow the cassette to be moved between its open and closed configurations.

The present invention includes exposure apparatus that combines both the exposure and post-exposure functions. Accordingly, a preferred exposure apparatus of the invention comprises a unit as described above which additionally comprises on at least one of the opposed sides of the space a germicidal light source arranged to irradiate (post-expose) an exposed plate received in the space. Usually, all the light sources are in normal use immovable relative to the body of the exposure unit. In the use of such preferred apparatus, a photopolymer-filled sachet is exposed by the actinic light sources to form a cured plate, which is washed out, contacted with hydrogen abstraction initiator to control tackiness and then dry post-exposed by the germicidal light source.

The actinic light sources usually each comprise a plurality of actinic bulbs. Any germicidal light source usually comprises a plurality of germicidal bulbs.

The actinic light sources possess a wavelength distribution mainly emitting radiation within the range comprising UVA radiation (315 to 400 nm) and UVB radiation (280 to 315 nm). Such radiation range activates the photoinitiators in the photosensitive resin. The germicidal source, when present, possesses a lower wavelength, emitting UVC radiation within the range from 200 to 280 nm. All H-abstraction photoinitiators are activated by UVC radiation. The light sources are connected to a power supply and control system, the latter including a timer. Preferably, each light source (and in one preferred embodiments each set of lights) is connected separately to a respective power source and control system.

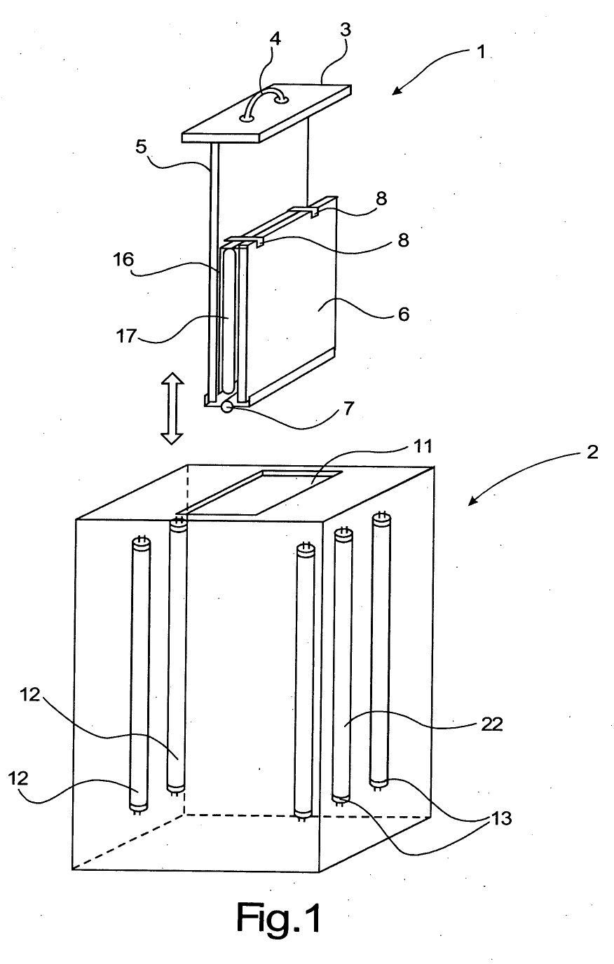

The apparatus of the invention is illustrated by FIGS. 1 to 4. FIG. 1 shows a cassette 1 adapted for use with an exposure unit 2. The cassette comprises a base plate 3, which is opaque to ultra-violet light and normally made of metal, provided with a handle 4; extending substantially perpendicularly to the base plate 2 is a first rigid plate 5 which is made of glass or another material transparent to actinic and, in this case, germicidal radiation. The glass plate 5 is firmly secured to the base plate 3 but may be removable therefrom, for example for cleaning. A second rigid plate 6, also made of glass or another material transparent to actinic and, in this case, germicidal radiation is pivotally coupled to the first glass plate 5 by a hinge 7. The hinge 7 permits the second glass plate 6 to pivot from the illustrated closed position to an open position in which a photopolymer package may more readily be placed between the glass plates, the hinge 7 is adapted to space the hinged end of the first 5 and second 6 glass plates from each other by a selected amount, and preferably by about 2.3 mm. The two glass plates 5 and 6 are usually not substantially more than A4 sized, in particular for the European market, or usually not more than letter paper sized for the American market.

The edge of the second glass plate 6 which is remote from the hinge 7 is shown to be held in a closed position by one or more clips 8. There may also be provided one or more spacer devices (not shown) to maintain the spacing between said edge and the first glass plate 5. The spacers may be in the form of a stop on the or each clip 8 or be separate from the clip(s) but fixedly or pivotally connected to the first glass plate 5; alternatively they may be slideable between the two glass plates 5 and 6.

It will be appreciated that the cassette may vary considerably from that illustrated. For example, the two glass plates may be fixed relative to each other, or another arrangement may be provided to allow them to move between open and closed configurations; for example one or both glass plates may be pivotally coupled to the base plate or the second glass plate 6 may be arranged to slide relative to the first glass plate 5.

FIG. 1 shows photographic negative 9 and a package 10 of the invention to be held in the space defined between the two glass plates 5 and 6.

FIG. 1 also shows in stylised form an exposure unit 2 of the invention, having defined in it a mouth 11 adapted to receive the cassette 1 such that the two glass plates 5 and 6 extend into the exposure unit and the base plate 3 of the latter sits in or over the mouth 11; for example a ledge (not shown) may be provided round the periphery of the mouth 11 to provide a seat for the base plate 3. The exposure unit 2 contains one or more sources of curing radiation and in this case contains a first actinic light source constituted by one or more actinic bulbs 12 of a first bulb set and a second actinic light source constituted by one or more actinic bulbs 13 of a second bulb set. The first and second actinic light sources, which are for exposing and curing uncured polymer, are in opposed relationship and define between them an exposure space to receive the glass plates 5 and 6 of the cassette 1 and any package between the glass plates. The exposure unit 2 preferably includes a germicidal light source, shown as constituted by one or more germicidal bulbs 22, for post-exposure of cured plates.

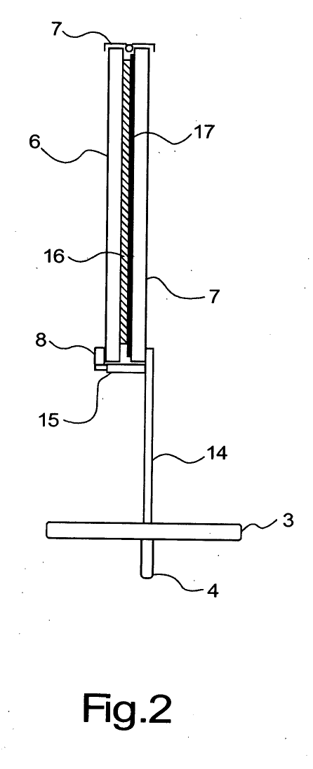

FIG. 2 shows a side view of a second embodiment of the cassette 1, in which the first glass plate 5 is secured to the base plate 3 through a rigid, preferably metal, plate member 14. The clips 8 are shown in this case to be pivotally mounted on a flange 15 provided perpendicularly on the plate member 14; the flange 15 may also carry one or more protuberant spacers to ensure that a selected minimum separation is maintained between the two glass plates 5 and 6.

Whatever the design of the cassette, it may be modified to allow the user to select one of two or more choices as to the separation between the glass plates, for example the separation may be freely selectable between limits.

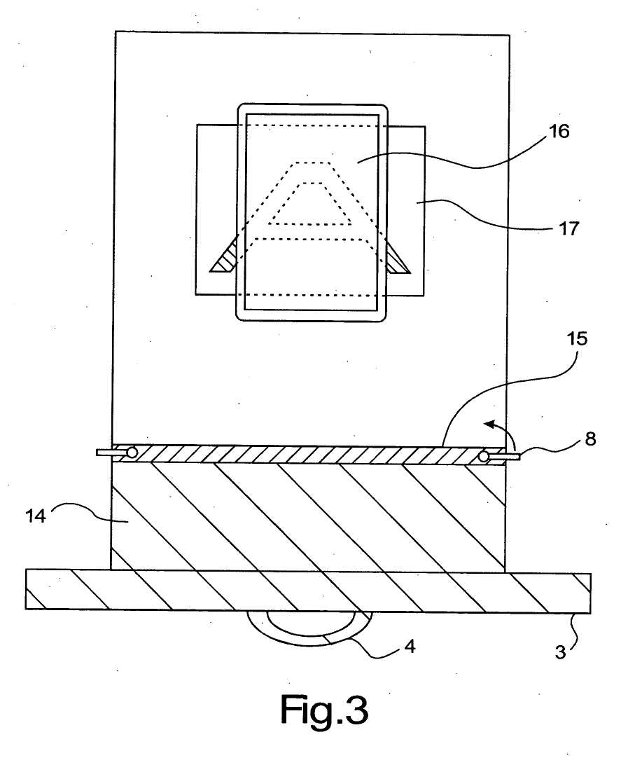

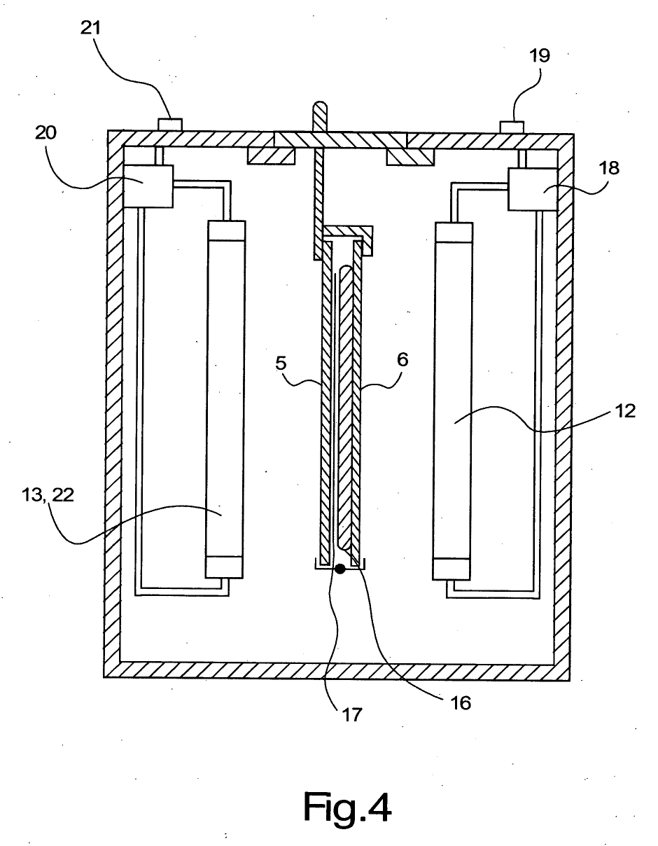

FIG. 3 is a view of the cassette of FIG. 2 showing a photopolymer package of the invention 16 and a negative 17, whilst FIG. 4 is a diagrammatic cross section of the exposure unit 2 when containing the cassette 1 of FIG. 2, showing a power source and specifically a ballast 18 for the actinic bulbs 12. The power source (ballast) is coupled to a switch 19 coupled to the ballast and for switching on the actinic bulbs to cure the photopolymer of a package of the invention; usually, the power source and switch are coupled to a control circuit which comprises a timer for maintaining the actinic bulbs in “on” status for a desired time period, which period may or may not be variable by the user. FIG. 4 likewise shows a power source (ballast) 20 and switch 21 for the germicidal lights, both of which are coupled to a control circuit comprising a variable or invariable timer. Of course, the control circuits may be dispensed with, if fully manual control is desired.

The present invention includes therefore (but is not limited to) a photopolymer exposure unit that combines both the exposure and post-exposure functions. More particularly it describes a new concept in processing that does not require the presence of a separate post-exposure unit or, in preferred processes, the presence of a water bath in which to conduct the post exposure. The exposure unit also has the convenience that it is not necessary to level the exposure bed prior to use, because it is used to expose pre-made sachets of photopolymer. In fact this exposure unit, unlike all others, can be presented in a horizontal or vertical format.

The exposure apparatus of the invention is in principle simple in design, yet has the capacity to manufacture printed images of the highest quality. It preferably (but not necessarily) has a combined exposure and post-exposure system, that does not have to be levelled and is adapted for use with a pre-filled photopolymer sachet containing a metered quantity of liquid photopolymer (photocurable preparation). These aspects significantly reduce its cost of manufacture whilst not compromising its quality of performance. Hand stamp manufacturers tend to make little investment in capital equipment and this apparatus, being very cost-effective, is well suited to them. Although all manufacturers using liquid photopolymer will have to purchase a basic UV exposure unit, few purchase more sophisticated apparatus.

Few hand stamp manufactures have vacuum supplied to their machines to remove the entrapped air from between the negative and the coverfilm. The presence of this air impairs the resulting image. As has been described earlier, it has been found that when the user makes a plate using a pre-packed sachet system the quality of the image is superior to that made by manual assembly of the components.

Some companies do not have an automated wash out unit and instead wash out under the tap in a sink. This invention allows the washing out process to take place manually or with an automated wash out system (supplied for instance by AZ, Italy).

Some companies do not have a separate post exposure unit in which the plate is submerged in a water bath containing salts and exposed under actinic radiation to achieve a tack free surface, and instead achieve a dry surface by dusting it with talcum powder. This quickly clogs the printing relief and has to be replenished regularly. In a preferred embodiment, this invention provides post exposure and exposure lighting within the same unit, although the invention is not limited to this feature.

Most exposure units require manual adjustment to level them to be perfectly horizontal. This exposure unit requires no levelling and can stand have the sachet in any orientation, for example vertical (i.e. edges at top and bottom) or horizontal (i.e. faces at top and bottom).

Most existing exposure units have to be machined to produce two hinged glass plates that can open and then close to deliver an accurate space evenly set at the plate thickness (in hand stamps often about 2.3 mm). This invention allows the unit to be manufactured without any requirement for fine tolerances. The thickness of the printing plate is instead set accurately and by the cassette holding the sachet.

Drying of the post-exposed plate may be achieved by means of any suitable technique, but the preferred method is air drying at an elevated temperature, typically around 60° C., and this is generally carried out in an oven. One alternative is to allow the plate to dry under ambient conditions. The drying procedure may, of course, be effected before the post exposure treatment in the event that this treatment is to be carried out under dry conditions.

The resulting photorelief plate is preferably designed for use in the preparation of hand stamps.

Various aspects of the invention will now be particularly described with reference to the following examples:

### EXAMPLES

### Example 1

Package Manufacture

A pouch having the dimensions 12 inches×8⅗ inches (30.5 cm×21.8 cm), and sealed on three sides, was pre-formed from a laminate of polyethylene film of 70 μm thickness and polyethylene terephthalate film of 12 μm thickness, having an adhesive interlayer.

A photopolymer composition (21.7 g) comprising a polyether urethane liquid photopolymer (Verbatim® photopolymer from Chemence Limited, Corby, NN17 4XD, United Kingdom, or from Chemence Inc of Alpharetta, Ga. 30201, USA), UK) Ltd, UK) was then introduced into the pouch through a fill tube, and the pouch was placed in a Multivac® C400 vacuum packing apparatus such that it was laid at an angle against the seal bar, with the open end against the seal bar. A vacuum was then applied to draw the sides of the sachet together at the open end and remove most of the entrapped air, and the seal bar was applied in order to heat seal the top of the sachet. The resulting photopolymer package, which had a thickness of 1/8 inch (0.32 cm), produced an image area of 11 7/10 inches×8 3/10 inches (30.5 cm×21.8 cm) and was ready for use in a platemaking operation.

### Example 2

Package Manufacture

A reel of laminated polyethylene/polyethylene terephthalate of the type disclosed in Example 1, and having a width of 7⅕ inches (18.2 cm), was fed into an automatic sachet packaging machine. The machine included a blade disposed to slit the laminate into two equal sections and was designed to propel the sections so formed in opposite directions at 90° to the reel through a film divider unit.

The inner sides of the two sections of the laminate were then positioned vertically to face each other and brought together. The bottom and side sections of the assembly were then heat sealed by means of horizontal and vertical heat sealing dies respectively, to form an open sachet.

A photopolymer composition (21.4 g) as disclosed in Example 1 was then pumped into the sachet through a fill tube under vacuum, the assembly was advanced through the machine, and the horizontal and vertical crimp heat sealing dies were reapplied in order to heat seal the top of the sachet—at the same time forming the bottom seal of the next sachet—and seal the sides of the next sachet, which was then ready for filling in the same manner as above. Sachets having dimensions of 4 5/16 inches×3⅗ inches (11.0 cm×9.1 cm) are produced in this way. The sachets have a thickness of 1/10 inch (0.23 cm) and provide an image area of 4 inches×3¼ inches (10.2 cm×8.3 cm).

The individual sachets in the continuous web produced by continuing the process hereinbefore described through a number of iterations are separated by cutting means, and the sachets are then ready for use in the production of a hand stamp printing plate.

As previously discussed, the packages of the present invention show significant advantages over the prior art in that there is no requirement for the use of a backing sheet to provide support for the solidified resin forming the hand stamp base. In the present embodiment, these advantages are enhanced by the fact that there is no need to take any of the precautions or steps necessary to expel air from the sachet after it has been formed. Air is not trapped, and does not collect, in the sachet in an amount sufficient to provide problems in the future preparation of a printing plate and the method thereby offers advantages in terms of cost and time.

In the other embodiments of the method of the invention, whereby the sachet is overfilled—or a vacuum is applied—to avoid incorporating air bubbles from the sachet, the techniques involved are much simpler than those of the prior art as a consequence of the elimination of the requirement for the use of a backing sheet. The hand stamp base may conveniently be affixed to a suitable handle in order to provide a hand stamp which is ready for use. The hand stamps are found to perform to a high standard when employed in practice, typically in an office environment.

### Example 3

Sachet Evaluation

Various plastics materials were evaluated for performance when used to form a sachet. In each case, the plastics material was formed into a pouch, and the sealed photopolymer package was produced as detailed in Example 1, using the photopolymer preparation described therein. The sealed package had a thickness of 3.2 mm, and was given a main exposure to curing radiation for 60 seconds, and a back exposure for 55 seconds. The appearance of the resulting plate was examined and the results are detailed in Table 1.

The results of these tests show clearly the effects of increasing film thickness.

TABLE 1

| | UV light | | |
|---|---|---|---|
| Type of flexible film | transmission | Plate image | Delamination |
| OPA 12 μm: PE 30 μm | Av. 92.1% | Very good image; difficult | Very easy |
| | | to handle (stretches easily) | |
| OPA 12 μm: PE 40 μm | Av. 90.9% | Very good image | Very easy |
| OPA 12 μm: PE 50 μm | Av. 90.0% | Very good image | Very easy |
| OPA 12 μm: PE 60 μm | Av. 89.8% | Very good image | Very easy |
| OPA 20 μm: PP 70 μm | Av. 90.9% | Relatively good; | Very easy |
| | | sharp letters but some areas | |
| | | with bad image | |
| PETP 12 μm: PE 30 μm | Av. 90.3% | Very good image | Very easy |
| PETP 12 μm: PE 50 μm | Av. 87.8% | Very good image | Very easy |
| PETP 12 μm: PE 60 μm | Av. 85.0% | Very good image | Very easy |
| PETP 12 μm: PE 80 μm | Av. 86.1% | Very good image | Easy |
| PETP 12 μm: PE 100 μm | Av. 83.7% | Very good image | Can only be |
| | | | removed |
| | | | slowly with care. |
| PETP 12 μm: PE 130 μm | Av. 81.2% | Very good image | Very difficult to |
| | | | remove. |
| PETP 12 μm: PE 150 μm | Av. 80.3% | Good image | Delaminates. |
| PETP 12 μm: PETP 12 | Av. 85.4% | Bad image | Easy |
| μm: PP 70 μm | | | |
| M-PETP-Y 12 μm: PE 70 | Av. 68.1% | Very good image | Delaminates |
| μm | | | |

Key: OPA = Orientated Polyamide
PE = Polyethylene
PP = Polypropylene
PETP = Polyethylene Terephthalate
M-PETP-Y = Modified Polyethylene Tereplithalate

### Example 4

Dry Post Exposure

A polyether urethane based photopolymer plate is made in the conventional way using Verbatim VX50 photopolymer (from Chemence, UK). It is washed out in an automated wash out system (from AZ, Italy). It is transferred to a drying unit set at 55 degrees C. to evaporate all of the water.

20 g of Esacure TZM (from Lamberti Spa, Italy) is mixed with 80 g of butylacetate. This mixture is filled into a pump spray bottle. The bottle is shaken well and a fine spray is coated all over the imaged side of the printing plate. The plate is then dry post-exposed under germicidal UV light of a wavelength of 250 nm for 10 minutes. The resulting plate has a smooth and completely tack free surface.

Esacure TZM is a photoinitiator preparation containing a 50:50 by weight mixture of 4-methylbenzophenone and benzophenone.

### Example 5

Operation of Exposure Unit

A pre-packaged sachet of polyether urethane based photopolymer (from Photocentric Ltd, UK) is placed with a photographic negative into a cassette. The cassette is inserted into the exposure unit described. The button that controls both the main and back exposure is pressed and this exposure is carried out for 20 seconds for back (floor) and 80 seconds for main (relief). The cassette is removed and the sachet is hand washed under a tap using detergent. The plate is then air dried for 10 minutes.

20 g of Esacure TZM (from Lamberti Spa, Italy) is mixed with 80 g of butylacetate. This mixture is filled into a pump spray bottle. The bottle is shaken well and a fine spray is coated all over the imaged side of the printing plate.

The plate is then reinserted in the same equipment. The button that initiates the post exposure lights is depressed by the user and the plate is dry post-exposed under germicidal UV light for 10 minutes.

The resulting plate has a smooth and completely tack free surface and is of excellent quality.

Although the present invention has been shown and described with reference to the foregoing operational principles and preferred embodiments, it will be apparent to those skilled in the art that various changes in form and detail may be made without departing from the spirit and scope of the invention. The present invention is intended to embrace all such alternatives, modifications and variances that fall within the scope of the appended claims.

What is claimed is:

1. A photopolymer package for use in making a hand stamp plate, the package consisting of a sealed sachet and a curable liquid photopolymer preparation contained in the sachet, the sachet being formed of material which is releasable from the cured photopolymer.

2. The package of claim 1 wherein the sachet is rectangular and has four sides, all of which sides comprise seals between opposed sheets of said material.

3. The package of claim 1 wherein the sachet is rectangular and is formed of a single sheet of said material, the sachet having four sides, three of said sides comprising seals between opposed portions of said sheet and one of said sides comprising a fold between said portions.

4. The package of claim 1 wherein the photopolymer comprises an unsaturated polyurethane resin.

5. A method for forming a photopolymer package adapted for use in making a hand stamp, the method comprising filling an envelope with a photocurable liquid polymer and sealing the envelope to form such a package consisting of a sealed sachet and said polymer, the envelope being made of material which is releasable from the cured photopolymer.

6. The method of claim 5 wherein the envelope comprises a pre-formed pouch formed from a sheet or sheets neither of which adheres to the cured photopolymer and has a mouth formed between adjoining portions of the sheet or sheets to receive the liquid curable polymer, the method comprising introducing the photocurable liquid polymer into the pouch by way of the mouth to fill the envelope to a level less than its capacity; applying a vacuum to draw the sides of the pouch together above the level of the photopolymer; and then sealing the adjoining portions of the sheet or sheets together to form a package consisting of a sealed sachet and said polymer.

7. The method of claim 5 wherein the envelope is sealed in a vacuum packing machine.

8. The method of claim 5 which is a form-fill-seal process which comprises: forming the envelope from a sheet or sheets, neither of which adheres to the cured photopolymer, the envelope having a mouth formed between adjoining portions of the sheet or sheets to receive the liquid curable polymer; introducing the photocurable liquid polymer into the envelope by way of the mouth of the envelope to fill the envelope; and then sealing the portions of the sheet or sheets together to form the package.

9. The method of claim 8 which comprises a vertical fill-form-seal technique.

10. The method of claim 5 wherein the envelope is formed from two sheets.

11. The method of claim 5 wherein the envelope is formed from a single sheet.

12. A receptacle for use in forming a photopolymer package, comprising an envelope of plastics sheet material, the plastics sheet material having a thickness of from 30 μm to 180 μm and the characteristics that it is heat sealable, substantially transparent to actinic radiation, and if contacted with photosetting resin during curing of same it can thereafter be released from the cured resin, the envelope having opposed major surfaces, each major surface having three edge regions which are arranged as three sides of a rectangle generally of hand stamp size and are sealedly connected to an opposed edge region of the other major surface, and the region of each major surface which is located in the position of the fourth side of the rectangle between end regions of two of said three edges, defining together with an opposed region of the other major surface a mouth to receive liquid photosetting resin.

13. The receptacle of claim 12 which is made of
(i) two separate sheets of plastics material, wherein the sealedly connected edge regions are connected together by heat sealing; or
(ii) a single sheet of plastics material, wherein the sealedly connected edge regions are at one said side connected as one piece, the sealedly connected edge regions at the remaining two of said three sides being connected together by heat sealing.

14. The receptacle of claim 13 which is adapted to have a thickness of from 2.2 mm to 3.2 mm when filled with a liquid.

15. The receptacle as claimed in claim 12 in which the surfaces of the envelope are made of the same material.

16. The receptacle as claimed in claim 12 wherein the material comprises one or more polyolefins.

17. The receptacle as claimed in claim 12 wherein the material is selected from the group consisting of polyolefins, oriented polyamide, polyethylene terephthalate, modified polyethylene terephthalate and laminates thereof.

18. The receptacle as claimed in claim 17 wherein the material is selected from the group consisting of polyolefins and laminates of polyethylene with a polyethylene terephthalate product.

19. The receptacle as claimed in claim 12 wherein the thickness of the plastics sheet material is in the range from about 50 μm to about 100 μm.

20. The receptacle as claimed in claim 12 wherein the thickness of the plastics sheet material is in the range from about 50 μm to less than about 95 μm.

21. The receptacle as claimed in claim 17 wherein the thickness of the plastics sheet material is in the range from about 60 μm to about 90 μm.

22. The receptacle as claimed in claim 15 wherein:
the material is selected from the group consisting of polyolefins and polyolefin laminates; and
the thickness of the sachet walls is from about 50 μm to about 100 μm.

23. The receptacle of claim 13 wherein the resin comprises a polyether polyester urethane methacrylate, the thickness of the walls of the envelope is in the range from about 60 μm to about. 90 μm and the walls are made of a material selected from the group consisting of polyolefins and polyolefin laminates.

24. A photopolymer package adapted for use in making a hand stamp plate, the package consisting essentially of a sealed sachet and, contained in the sachet, a curable liquid photopolymer preparation which, when the package is exposed to curing radiation, cures to form a cured photopolymer of hand stamp quality, the walls of the sachet being formed of material which is releasable from the cured photopolymer.

25. The photopolymer package as claimed in claim 24 wherein the walls of the sachet are made of the same material, the material having a high degree of crease resistance and UV transmittance but not seriously diffracting transmitted UV radiation.
